(19) United States
(12) Patent Application Publication
(10) Pub. No.: US 2023/0256359 A1
(43) Pub. Date: Aug. 17, 2023

(54) SUPPLEMENTAL DEMULSIFIER ADDITIVE

(71) Applicant: Dow Global Technologies LLC, Midland, MI (US)

(72) Inventors: Rafael F. De Santi Ungarato, Jundiaí (BR); Milena Avancini, Jundiai (BR); Pedro H. Figueiredo, Jundiai (BR); Juan Pablo Watty, Alvaro Obregon (MX)

(21) Appl. No.: 18/007,060

(22) PCT Filed: Sep. 22, 2021
(86) PCT No.: PCT/US2021/051402

§ 371 Date: Jan. 27, 2023

Related U.S. Application Data
(60) Provisional application No. 63/082,024, filed on Sep. 23, 2020.

(51) Int. Cl. B01D 17/04; C10G 33/04

(52) U.S. Cl. CPC B01D 17/047; C10G 33/04

(57) ABSTRACT

Embodiments relate a demulsifier composition that includes a base demulsifier component and a supplemental demulsifier additive that is different from the base demulsifier component including, based on a total weight of the supplemental demulsifier additive, from 1 wt % to 30 wt % of at least one polyol block copolymer, from 1 wt % to 30 wt % of at least one alkoxylated alkyl phenol formaldehyde resin, and from 20 wt % to 98 wt % of at least one modified silicone polyether. The supplemental demulsifier additive is present in an amount from 10 ppm to 10,000 ppm in the demulsifier composition.

### FIELD

Embodiments relate to a supplemental demulsifier additive, a demulsifier that includes a base demulsifier and the supplemental demulsifier additive, an emulsion including the demulsifier that includes the base demulsifier and the supplemental demulsifier additive, and a method of demulsifying an emulsion including adding the demulsifier that includes the base demulsifier and the supplemental demulsifier additive.

### INTRODUCTION

Certain techniques used in extracting crude oil from an oil field can produce an emulsion of the oil and water. The emulsion is an undesirable system that needs to be broken into a water phase and an oil phase. Once broken, the oil phase can then go on for further processing. A variety of techniques can be used in trying to destabilize the emulsion. Such methods include thermal, chemical, and/or electrostatic methods. With respect to chemical techniques, demulsifiers (also known as “emulsion breakers”) are chemical compounds that can be used to destabilize such emulsions. Demulsifiers are surfactant like molecules that are active at the boundary surface between emulsion components, e.g. the water and the oil, and are capable to provoke the separation of the emulsion components. These chemicals may be used with a change in temperature, e.g., to make the oil less viscous, agitate the movement of the water droplets in the emulsion, and/or accelerate the emulsion breakdown.

While demulsifiers do currently exist, the increasing complex characteristic of produced crude oil and the impact of environmental conditions (such as temperature), requires developing further technologies to improve the already existing demulsifiers. It is proposed that the performance of demulsifiers can be improved on a selective basis, e.g., in specific regions/environmental conditions, by use of a supplemental demulsifier additive that can be selectively added to a base demulsifier.

### SUMMARY

Embodiments may be realized by providing a demulsifier composition that includes a base demulsifier component and a supplemental demulsifier additive that is different from the base demulsifier component. The supplemental demulsifier additive includes, based on a total weight of the supplemental demulsifier additive, from 1 wt % to 30 wt % of at least one polyol block copolymer, from 1 wt % to 30 wt % of at least one alkoxylated alkyl phenol formaldehyde resin, and from 20 wt % to 98 wt % of at least one modified silicone polyether. The supplemental demulsifier additive is present in an amount from 10 ppm to 10,000 ppm in the demulsifier composition.

### BRIEF DESCRIPTION OF THE DRAWINGS

Features of the embodiments will become more apparent to those of ordinary skill in the art by describing in detail exemplary embodiments thereof with reference to the detailed description and attached drawings in which:

FIG. 1 illustrates demulsification results for the Examples.

### DETAILED DESCRIPTION

During oil production, oil can be produced in combination with water as the crude oil-water emulsion. The crude oil-water emulsion is an undesirable product that should be destabilized. Destabilizing the emulsion can be performed for economic and technical reasons. For example, destabilizing the emulsion can be performed to avoid the uneconomical transport of water, to minimize corrosion problems, and to reduce energy consumption for transport pumps. Further, in order for the oil to be suitable for pipeline transportation it may be necessary to reduce the water content to below specified industry standards.

By the term emulsion, it is meant a mixture of at least two immiscible liquids, that includes at least one liquid phase (the dispersed liquid phase) dispersed in the other liquid phase (the continuous liquid phase). By the term demulsifier, it is meant one or more chemical compounds that lower the interfacial tension between at least two liquids in an emulsion and is capable of provoking the separation of the emulsion into at least two liquid phases. By the term destabilizing, it is referring to the breaking of the emulsion into its separate liquid phases by at use of at least one chemical demulsifier. A demulsifier may be introduced into an emulsion (with or without the use of a solvent) and the contents mixed. The volume of the separated water and oil may be read at various time intervals until the volume of the settled water stops increasing. The clarity of the water and presence of sludge, filament and cloudiness may be noted to determine effectiveness.

By the term oil it is meant a naturally occurring liquid including a complex mixture of hydrocarbons of various molecular weights and structures, and other organic compounds, which are found in geological formations beneath the earth's surface. Oil may also refer to, as petroleum and/or crude oil. By the term water, it is meant to include a brine, a connate water, surface water, distilled water, carbonated water, sea water and any combination thereof.

Embodiments relate to use of a supplemental demulsifier additive in a demulsifier composition for use in a water-oil emulsion, such as crude oil in the form of a water-oil emulsion. The supplemental demulsifier additive is added to a base demulsifier component, such as one that is known for use in the art, in a minor amount in an effort to further improve performance of the demulsifier composition on an as needed basis. The supplemental demulsifier additive is different from the base demulsifier component. The supplemental demulsifier additive is a separate blend, that while it may include one or more demulsifiers, it is used in a different manner and amount, and is directed toward providing specific enhancements to the base demulsifier component. By using the supplemental demulsifier additive in a minor amount, performance of the base demulsifier can be improved when desired without significant costly changes, such as without having to change the type of base demulsifier being used, and/or while managing costs.

For example, the supplemental additive may only be added on days when improved performance is sought based on environmental conditions such as temperature (e.g., low temperature). Use of the supplemental demulsifier additive provides options to an end user, e.g., to use only when certain environmental conditions such as low temperature are present. By minor amount it is meant a small amount, e.g., such as less than 10,000 ppm (such as less than 10,000 milligrams per liter of the base demulsifier component) and greater than 10 ppm (such as greater than 10 milligrams per liter of the base demulsifier component). For example, the dosage may be from 10 ppm to 10,000 ppm, 10 ppm to 5,000 ppm, 10 ppm to 2,000 ppm, 50 ppm to 1000 ppm, 50 ppm to 500 ppm, 100 ppm to 300 ppm, etc. (per liter of base demulsifier component). A demulsifier, that includes the supplemental demulsifier additive, may be used as a demulsifier for oil-water emulsions.

### Supplemental Demulsifier Additive

The supplemental demulsifier additive is a specific blend that can be added to a base demulsifier component to further improve performance, e.g., at low temperatures (such as from 30° C. to 50° C., from 35° C. to 45° C., from 39° C. to 41° C., etc.) in water-oil emulsions (such as a crude water-oil emulsions). The supplemental demulsifier additive is different from the base demulsifier component, e.g., different composition, present in a different amount, and different in use as based on selective use. An end user may decide when and where to add the supplemental demulsifier additive to the base demulsifier component. The supplemental demulsifier additive may be a pre-blended composition, such that it is formed/blended prior to being added to the base demulsifier component. The supplemental demulsifier additive may be stored separately from the base demulsifier component, e.g., prior to use. The supplemental demulsifier additive may be mixed with the base demulsifier component in the presence of the emulsion (e.g., the water-oil emulsion) and/or prior to being added to the emulsion.

The supplemental demulsifier additive includes a blend of at least three different types of polymers. In particular, at least one polyol block copolymer, at least one alkoxylated alkyl phenol formaldehyde resin, and at least one modified silicone polyether. The supplemental demulsifier additive may further include at least one solvent, e.g., an alcohol (i.e., a material with at least one —OH group). In exemplary embodiments, the supplemental demulsifier additive may consistent essentially of the at least one polyol block copolymer, the at least one alkoxylated alkyl phenol formaldehyde resin, the at least one modified silicone polyether, and the at least one solvent. In exemplary embodiments, the supplemental demulsifier additive may consistent essentially of one polyol block copolymer, one alkoxylated alkyl phenol formaldehyde resin, one modified silicone polyether, and one solvent.

By polyol block copolymer it is meant a polyol derived from at least two alkylene oxides. For example, the polyol block copolymer may be derived from at least two of propylene oxide, ethylene oxide, and butylene oxide. The polyol block copolymer may include a first block derived from at least one of propylene oxide, ethylene oxide, and butylene oxide and a second block that is different from the first block and derived from at least one of propylene oxide, ethylene oxide, and butylene oxide. The polyol block copolymer may have a number average hydroxyl (OH) functionality from 2 to 8 (e.g., 2 to 6, 2 to 4, etc.). The polyol block copolymer may have a weight average molecular weight from 500 g/mol to 5000 g/mol (e.g., 500 g/mol to 4,000 g/mol, 1,000 g/mol to 4,000 g/mol, 1,000 g/mol to 3,000 g/mol, 2,000 g/mol to 3,000 g/mol, 2,300 g/mol to 2,700 g/mol, etc.) The polyol block copolymer may be a propylene oxide/ethylene oxide polyether polyol (i.e., a polyether polyol formed from addition of propylene oxide and ethylene oxide). The polyol block copolymer may have a relative solubility number (RSN) from 15 to 20 (e.g., may be soluble in water at ambient conditions). Herein, RSN is reported as the volume of water needed to make a solution turbid or cloudy at ambient conditions.

The at least one polyol block copolymer may be present in an amount from 1 wt % to 30 wt % (1 wt % to 25 wt %, 1 wt % to 20 wt %, 1 wt % to 15 wt %, 2 wt % to 13 wt %, 3 wt % to 12 wt %, etc.), based on a total weight of the supplemental demulsifier additive.

By alkoxylated alkyl phenol formaldehyde resin it is meant polymer obtained from the alkoxylation of an alkyl phenol formaldehyde resin. The alkyl phenol formaldehyde resin may be a C1 to C20 alkyl (said in another way, includes 1 to 20 carbon atoms, in exemplary embodiments may be C7 to C11 alkyl) phenol-formaldehyde resin. The alkoxylated alkyl phenol formaldehyde resin may be ethoxylation (ethylene oxide addition), propoxylation (propylene oxide addition) and/or buthoxylation (butylene oxide addition) of the alkyl phenol formaldehyde resin. The alkoxylated alkyl phenol formaldehyde resin may have a weight average molecular weight from 500 g/mol to 10,000 g/mol (e.g., 1,000 g/mol to 8,000 g/mol, 2,000 g/mol to 7,000 g/mol, 3,000 g/mol to 6,000 g/mol, 3,500 g/mol to 5,500 g/mol, 4,300 g/mol to 5,000 g/mol, etc.) The alkoxylated alkyl phenol formaldehyde resin may have a relative solubility number (RSN) from 15 to 20 (e.g., may be soluble in water at ambient conditions).

The at least one alkoxylated alkyl phenol formaldehyde resin may be present in an amount from 1 wt % to 30 wt % (1 wt % to 25 wt %, 1 wt % to 20 wt %, 1 wt % to 15 wt %, 2 wt % to 13 wt %, 3 wt % to 12 wt %, etc.), based on a total weight of the supplemental demulsifier additive.

By modified silicone polyether it is meant a silicone polyether that is further modified, e.g., modified by replacing methyl groups on silicones with other groups. A polysiloxane may be used to obtain the modified silicone polyether. The modified silicone polyether may include a methyl(polyethylene oxide polypropylene oxide acet. The modified silicone polyether may have a weight average molecular weight from 1,000 g/mol to 50,000 g/mol (e.g., 2,000 g/mol to 45,000 g/mol, 5,000 g/mol to 40,000 g/mol, 10,000 g/mol to 35,000 g/mol, 15,000 g/mol to 30,000 g/mol, 15,000 g/mol to 25,000 g/mol, etc.) The modified silicone polyether may have a relative solubility number (RSN) from 5 to 10, from 6 to 9, and/or from 7 to 8 (e.g., may be insoluble in water at ambient conditions). The modified silicone polyether may have the lowest RSN in the supplemental demulsifier additive, such that the polyol block copolymer and the alkoxylated alkyl phenol formaldehyde resin have a higher RSN than the modified silicone polyether.

The at least one modified silicone polyether may be present in an amount from 20 wt % to 98 wt %, (20 wt % to 90 wt %, 20 wt % to 85 wt %, 30 wt % to 80 wt %, 40 wt % to 80 wt %, 50 wt % to 70 wt %, 52 wt % to 60 wt %, etc.), based on a total weight of the supplemental demulsifier additive.

The at least one solvent may be any material or mixture thereof that is known for use in the art. For example, the solvent may be one or more alcohols or other organic solvents, e.g., may include one or more solvents such as alcohols or other organic solvents. Examples of solvents include water, methanol, ethanol, isopropanol, propanol, butanol, pentanol, n-propanol, glycerol, tertiarybutyl alcohol, amyl alcohol, benzyl alcohol, phenol, benzene, toluene, xylene, kerosene, and glycol ethers.

The at least one solvent may be present in an amount from 1 wt % to 50 wt % (1 wt % to 40 wt %, 5 wt % to 40 wt %, 10 wt % to 40 wt %, 15 wt % to 30 wt %, 20 wt % to 30 wt %, etc.) based on a total weight of the supplemental demulsifier additive.

### Base Demulsifier

The base demulsifier component may include any demulsifier known in the art, e.g., the base demulsifier may be the commercially available blends. Examples includes polyol block copolymers, alkoxylated alkyl phenol formaldehyde resin, epoxy resin alkoxylate, amine-initiated polyol block copolymer, silicone materials, etc. The base demulsifier component may include two or more base demulsifiers. In exemplary embodiments, the base demulsifier component may include one or more base demulsifiers available as DEMTROL™ products from The Dow Chemical Company or affiliated companies. The overall composition/blend that forms the base demulsifier component is different from the overall composition/blend that forms the supplemental demulsifier additive. Though, the composition/blend that forms the base demulsifier component may include one or more base demulsifiers that are the same as demulsifier additives in the supplemental demulsifier additive. For example, the base demulsifier component may include the at least one polyol block copolymer as discussed above, the at least one alkoxylated alkyl phenol formaldehyde resin as discussed above, and/or the at least one modified silicone polyether as discussed above.

In exemplary embodiments, at least one base demulsifier in the base demulsifier component is the same as at least one supplemental demulsifier in the supplemental demulsifier additive. By same it is meant the same compound and/or type of compound (e.g., the same polyol block copolymer compound or different types of polyol block copolymers. The base demulsifier may include a polyol block copolymer and/or an alkoxylated alkyl phenol formaldehyde resin, and may exclude any modified silicone polyether. In exemplary embodiments, the base demulsifier component includes from 10 wt % to 90 wt % (20 wt % to 80 wt %, 30 wt % to 70 wt %, 40 wt % to 60 wt %, etc.) of the same polyol block copolymer compound as the supplemental demulsifier additive and from 10 wt % to 90 wt % (20 wt % to 80 wt %, 30 wt % to 70 wt %, 40 wt % to 60 wt %, etc.) of the same alkoxylated alkyl phenol formaldehyde resin compound as the supplemental demulsifier additive, based on a total weight of the base demulsifier component.

### Examples

Approximate properties, characters, parameters, etc., are provided below with respect to the illustrative working examples, comparative examples, and the information used in the reported results for the working and comparative examples.

The following materials are used in the Examples to form the Supplemental Additive:
Additive 1 A demulsifier that is a propylene oxide/ethylene oxide polyol block copolymer, having a weight average molecular weight of approximately 2500 g/mol, an actives content of approximately 100%, a density of approximately 1.03 g/cm3 @ 25° C., and a RSN of approximately 17.8 (available from The Dow Chemical Company or affiliated company as DEMTROL™ 1030).
Additive 2 A demulsifier that is an alkoxylated alkyl phenol formaldehyde resin, having a weight average molecular weight of approximately 4500 g/mol, an actives content of approximately 70-85%, a density of approximately 1.01 g/cm3 @ 25° C., and a RSN of approximately 15.2 (available from The Dow Chemical Company or affiliated company as DEMTROL™ 2030).
Additive 3 A demulsifier that is a modified silicone polyether including an methyl(polyethylene oxide polypropylene oxide acet, having an actives content of approximately 100% and a RSN of 7.9 (available from The Dow Chemical Company or affiliated company as DEMTROL™ 6233).

RSN is referred to as relative solubility number and is determined by titrating water in a solution containing 1 gram of the DEMTROL™ demulsifier and 30 mL toluene (2.6 vol %) and ethylene glycol methyl ether (97.4 vol %). The RSN is reported as the volume of water needed to make a solution turbid or cloudy at ambient conditions. DEMTROL™ is a trademark of The Dow Chemical Company (“Dow”) or an affiliated company of Dow.

The water separation data is prepared using Oil having an API of approximately 18, and a composition with a saturates content of approximately 55 wt %, an aromatics content of approximately 31 wt %, a resins content of approximately 10%, and an asphaltenes content of approximately 3 wt % (based on a total weight of the Oil).

TABLE 1

| | | | Compar- | Compar- |
|---|---|---|---|---|
| | Working | Working | ative | ative |
| | Ex. 1 | Ex. 2 | Ex. A | Ex. B |
| | (wt %) | (wt %) | (wt %) | (wt %) |
| Composition | | | | |
| *Base Demulsifier | | | | |
| DEMTROL ™ 1030 | 50 | 50 | 50 | 50 |
| DEMTROL ™ 2030 | 50 | 50 | 50 | 50 |
| Total of Base (wt %) | 100 | 100 | 100 | 100 |
| *Supplemental Additive | | | | |
| Additive 1 | 11.5 | 3.7 | 0 | 41.2 |
| Additive 2 | 11.5 | 3.7 | 0 | 0 |
| Additive 3 | 53.8 | 67.4 | 0 | 49.0 |
| Ethanol | 23.2 | 25.2 | 0 | 9.8 |
| Total of Supplemental | 100 | 100 | — | 100 |
| Demulsifier Additive | | | | |
| (wt %) | | | | |
| Water Separation | | | | |
| at 40° C. (%) | | | | |
| 0 minutes | 4 | 6 | 1 | 6 |
| 30 minutes | 10 | 14 | 7 | 11 |
| 60 minutes | 68 | 64 | 10 | 16 |
| 90 minutes | 100 | 96 | 28 | 18 |

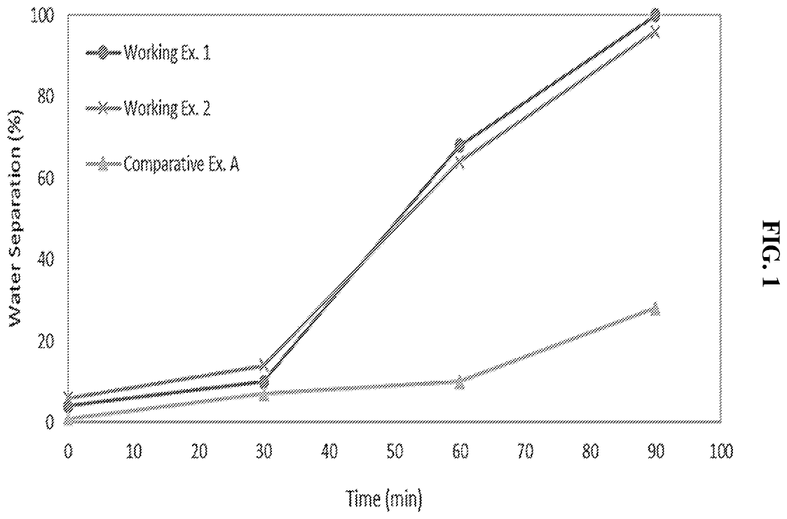

Working Examples 1 and 2 are prepared with a 200 ppm dosage of the supplemental demulsifier additive and Comparative Example B is prepared with a 200 ppm dosage of a comparative supplemental demulsifier additive. Comparative Example A is prepared without using a supplemental demulsifier additive. Working Examples 1 and 2 and Comparative Examples A and B are evaluated based on testing the water separation of the Oil at a low temperature, in particular 40° C. The water separation effectiveness is estimated using a bottle test methodology. In particular, graduated bottles are filled with 100 mL of an emulsion sample and heated in a water bath at 40° C. The relevant demulsifier formulation is added in the oil sample in the graduated bottle using a mechanical pipet. Then, once the demulsifier formulation is added, the bottles are shaken for 3 minutes in a agitating table and returned to the water bath. To evaluate the degree and speed of water separation for each sample, the amount of separated water is visually inspected relative to markings on the graduated bottle and periodically observed with estimates recorded in a bottle test sheet, as would be understood by one of ordinary skill in the art. As shown in Table 1 and FIG. 1, water separation is observed and recorded at 30 minute intervals.

For commercial use it may be desirable to achieve a water separation of at least 95% in a short amount of time (e.g., less than 100 minutes) even at low temperatures such as 40° C. Referring to Table 1 and FIG. 1, it is seen that Working Examples 1 and 2 are believed to achieve a desirable high level of water separation, even at a low temperature of 40° C., for the Oil over a short amount of time. In contrast, Comparative Examples A and B are believed to have difficulty achieving the desirable high level of water separation, at the low of temperature of 40° C., for the Oil at least in the first 100 minutes of the bottle testing. Therefore, it is shown that the supplemental demulsifier additive can significantly improve water separation performance for emulsions, e.g., such as crude water-oil emulsions.

1. A demulsifier composition, comprising:
a base demulsifier component; and
a supplemental demulsifier additive that is different from the base demulsifier component including, based on a total weight of the supplemental demulsifier additive, from 1 wt % to 30 wt % of at least one polyol block copolymer, from 1 wt % to 30 wt % of at least one alkoxylated alkyl phenol formaldehyde resin, and from 20 wt % to 98 wt % of at least one modified silicone polyether, the supplemental demulsifier additive being present in an amount from 10 ppm to 10,000 ppm in the demulsifier composition.

2. The demulsifier composition as claimed in claim 1, wherein the supplemental demulsifier additive includes from 1 wt % to 20 wt % of the at least one polyol block copolymer, from 1 wt % to 20 wt % of the at least one alkoxylated alkyl phenol formaldehyde resin, and from 40 wt % to 80 wt % of the at least one modified silicone polyether.

3. The demulsifier composition as claimed in claim 1, wherein the supplemental demulsifier additive includes from 1 wt % to 15 wt % of the at least one polyol block copolymer, from 1 wt % to 15 wt % of the at least one alkoxylated alkyl phenol formaldehyde resin, and from 50 wt % to 70 wt % of the at least one modified silicone polyether.

4. The demulsifier composition as claimed in claim 1, wherein the supplemental demulsifier additive further includes from 1 wt % to 50 wt % of at least one solvent, based on a total weight of the supplemental demulsifier additive.

5. The demulsifier composition as claimed in claim 1, wherein the supplemental demulsifier additive is a pre-blended additive that is added to the base demulsifier component.

6. The demulsifier composition as claimed in claim 1, wherein the at least one polyol block copolymer is propylene oxide/ethylene oxide polyether polyol having a weight average molecular weight from 500 g/mol to 5000 g/mol.

7. The demulsifier composition as claimed in claim 1, wherein the at least one alkoxylated alkyl phenol formaldehyde resin has a weight average molecular weight from 500 g/mol to 10,000 g/mol.

8. The demulsifier composition as claimed in claim 1, wherein the at least one modified silicone polyether includes a methyl(polyethylene oxide polypropylene oxide acet.

9. An emulsion, comprising:
oil;
water; and
the demulsifier composition as claimed in claim 1.

10. A method of demulsifying a crude water-oil emulsion, the method comprising adding to the crude water-oil emulsion the demulsifier composition as claimed in claim 1.
